(19) United States
(12) Patent Application Publication
(10) Pub. No.: US 2026/0049592 A1
(43) Pub. Date: Feb. 19, 2026

(54) High-Efficiency Wind Power Generation Device

(71) Applicant: Zhenkun Zack Wang, Cambridge, MA (US)

(72) Inventor: Zhenkun Zack Wang, Cambridge, MA (US)

(21) Appl. No.: 19/304,533

(22) Filed: Aug. 19, 2025

(30) Foreign Application Priority Data
Aug. 19, 2024 (CN) 2024220098321

(51) Int. Cl. F03D 1/06; F03D 9/00

(52) U.S. Cl. CPC F03D 1/0606; F03D 9/007

(57) ABSTRACT

This invention provides a compact, high-efficiency wind power device featuring permanent wind alignment and avian protection. The conical shell's large inlet and small outlet utilize the Venturi effect to accelerate airflow driving generator blades at the outlet. A counterweighted front support with bearing joint and rear adjustment plate ensures inlet alignment via the lever principle. A collision-prevention net and warning light are mounted at the inlet. The upper cylinder surface integrates solar panels to power the device internally.

### BACKGROUND TECHNOLOGY

Wind energy is a clean resource, and its utilization for power generation is a global consensus. Existing wind power devices exhibit low efficiency, with blades spanning tens to hundreds of meters. Such massive blades are excessively heavy and fail to rotate under low wind speeds, rendering power generation impossible. Small-scale wind turbines, while operable in most conditions, suffer from limited energy capture efficiency. Furthermore, existing devices struggle to align blades optimally with wind direction, failing to fully harness available wind energy.

Conventional wind turbines require substantial investment (e.g., blades weighing dozens of tons, hubs exceeding 100 meters) yet yield suboptimal energy returns. Installation atop mountains exacerbates avian mortality due to blade collisions, endangering species survival and conflicting with ecological sustainability.

### UTILITY MODEL CONTENT

This invention addresses the above limitations by providing a compact, high-efficiency device featuring permanent wind-alignment and avian protection.

The conical shell accelerates airflow via the Venturi effect, enabling blade

### ROTATION EVEN IN LOW WINDS

A counterweighted front support rod with bearing joint and lightweight rear adjustment plate leverages the lever principle for automatic wind alignment.

A collision-prevention net and warning light mitigate bird fatalities.

Solar panels on the upper cylinder surface supply auxiliary power for device operation.

### DRAWINGS DESCRIPTION

FIG. 1: External View

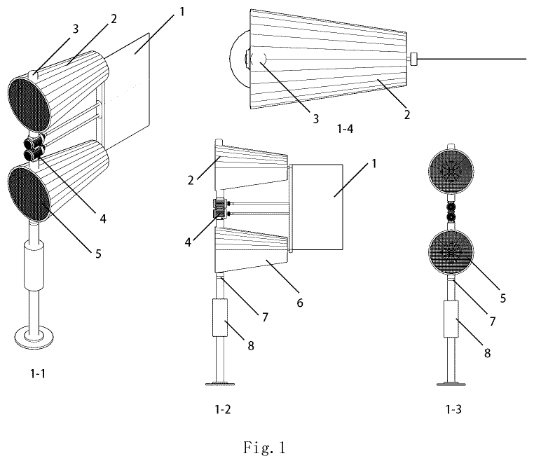

FIG. 2: Structure & Working Principle 1

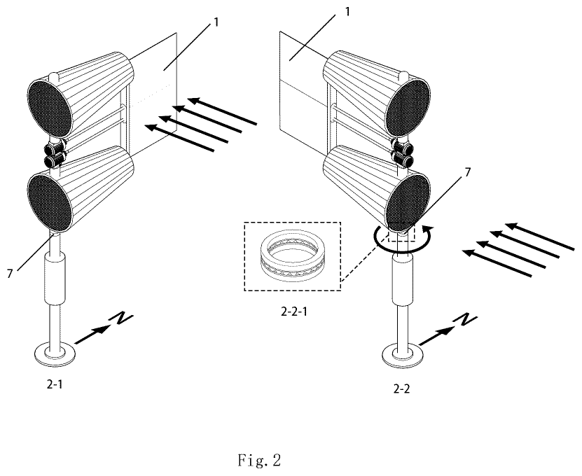

FIG. 3: Structure & Working Principle 2

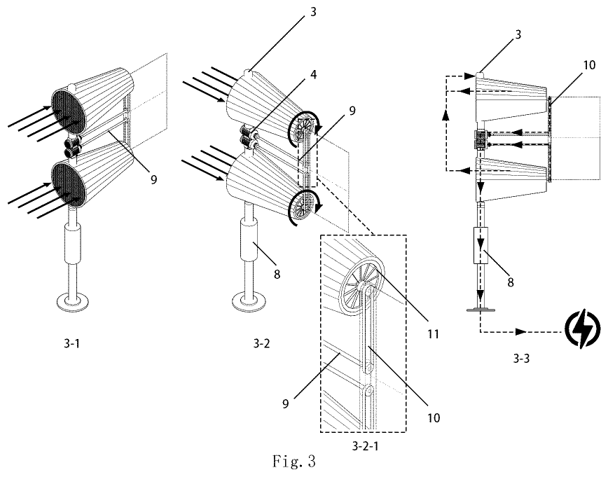

### LABELS

Wind direction adjustment plate
Solar panel
Warning light
Generator
Bird-proof net
Conical air acceleration channel
Rotating bearing
Battery
Drive shaft
Drive belt
11. Transmission fan

### Embodiment

Wind forces the adjustment plate 1 to orient the inlet optimally. Solar panels 2 power the system, while the warning light 3 enhances visibility. The generator 4 converts wind energy, protected by the bird-proof net 5. The conical channel 6 accelerates airflow, with the bearing 7 facilitating rotation. Energy is stored in the battery 8, and mechanical transmission is achieved via components 9 [symbol] 10 [symbol] 11.

What is claimed is:

1. A high-efficiency wind power generation apparatus, comprising:
(a) a conical cylindrical shell (6) having a larger end configured as an air inlet and a smaller end configured as an air outlet;
(b) a generator (4) with blades disposed at the air outlet;
(c) a support rod structure with a counterweight at a front end, the support rod structure being connected via a rotating bearing (7);
(d) a wind direction adjustment plate (1) mounted at a rear end;
(e) a bird-proof net (5) covering the air inlet;
(f) solar panels (2) integrated on an upper surface of the conical cylindrical shell; and
(g) a warning light (3) installed atop the apparatus.

2. The apparatus of claim 1, wherein the conical cylindrical shell (6) has a taper ratio between about 2:1 and 5:1.

3. The apparatus of claim 1, wherein the solar panels (2) are electrically connected to supply auxiliary power to the warning light (3).

4. The apparatus of claim 1, wherein the warning light (3) comprises a flashing beacon configured for visibility in low-light conditions.

5. The apparatus of claim 1, wherein the bird-proof net (5) comprises a corrosion-resistant mesh material.

6. A wind power generation method, comprising:
(a) accelerating incoming airflow through a conical channel (6) by a Venturi effect;
(b) driving rotation of generator blades (4) at the air outlet with the accelerated airflow;
(c) automatically aligning the air inlet with wind direction via the rear adjustment plate (1) and the bearing (7) utilizing a lever principle;
(d) preventing avian entry into the conical channel (6) using a bird-proof net (5); and
(e) powering the apparatus with energy collected by the solar panels (2).

7. The method of claim 6, wherein the airflow is accelerated by a conical channel tapering at an angle between 10° and 25°.

8. The method of claim 6, further comprising storing excess solar energy in a rechargeable battery coupled to the apparatus.

9. The method of claim 6, wherein aligning the air inlet with wind direction comprises
rotating the apparatus about the rotating bearing (7).

10. A method of using the apparatus of claim 1, comprising:
(a) operating the conical channel (6) to enhance airflow for blade drive under low-wind conditions;
(b) adjusting wind direction of the apparatus by the wind direction adjustment plate (1) and the bearing (7) for automatic yaw alignment in crosswinds;
(c) mitigating avian collision risks by employing the bird-proof net (5) and the warning light (3); and
(d) supplying auxiliary power to the apparatus with the solar panels (2).

11. The method of claim 10, wherein the warning light (3) is powered exclusively by the solar panels (2).

12. The method of claim 10, wherein the apparatus is mounted on a tower structure to increase exposure to wind.

13. The method of claim 10, wherein the bird-proof net (5) reduces airflow loss by less than 5 percent.
